(19) United States
(12) Patent Application Publication
(10) Pub. No.: US 2002/0199003 A1
(43) Pub. Date: Dec. 26, 2002

(54) Modem for internet connection

(76) Inventor: Frank Sacca, Diamond Bar, CA (US)

Correspondence Address: FRANK SACCA, 23036 Rio Lobos Road, Diamond Bar, CA, 91765, US

(21) Appl. No.: 10/122,678

(22) Filed: Apr. 15, 2002

Related U.S. Application Data
(60) Provisional application No. 60/283,745, filed on Apr. 13, 2001.

(51) Int. Cl. G06F 15/16

(52) U.S. Cl. 709/228; 709/236

(57) ABSTRACT

A stand-alone modem establishes a physical connection with the PSTN and a logical connection with the Internet. The modem supports basic Internet communication protocols such as E-mail, FTP, and HTTP through an extended AT command set without the need for a host processor.

### CROSS-REFERENCE TO RELATED APPLICATIONS

The present application is based on and claims priority to U.S. Provisional Application Serial No. 60/283,745, filed on Apr. 13, 2001.

### COPYRIGHT NOTICE

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

1. Field of the Invention

The present invention relates in general to telephone modems, and more specifically to an improved modem with built-in Internet communication capabilities.

2. Description of Related Art

Telephone modems have been available in the consumer market for over thirty years. Modems transfer digital information or data over standard telephone lines at the highest possible speed allowed by the telephone network, also referred to as the Public Switched Telephone Network (PSTN).

The PSTN was originally designed to communicate analog signals (voice) between two remote locations. Telephone users can communicate voice over a channel of relatively narrow frequency bandwidth, approximately 3 Kilohertz (Khz), from 0.3Khz to 3.3Khz, with negligible degradation of speech clarity. This channel bandwidth is purposely limited so that more subscribers can simultaneously communicate through the PSTN at any given time.

With the introduction of personal computers (PC's), the need for data communications developed and it was natural to look at an existing communication channel, such as the PSTN, to exchange data between systems at remote locations. Since the PSTN is essentially analog and was not designed specifically to support data communication, it became necessary to introduce modems as an interface or adapter between the PC and the PSTN.

Modems transmit and receive digital data in the form of analog signals through the essentially analog, band-limited PSTN. At the transmitter end, a stream of digital data or binary bits (0's and 1's) is modulated into an analog signal within the restricted bandwidth of the PSTN; at the receiver end, the analog signal is demodulated back to digital data. Hence, the portmanteau word mo-dem, which stands for mo(dulator)-dem(odulator)

In general, digital data can be transmitted through an analog channel at a maximum rate defined by the Shannon-Hartley theorem. This theorem states that the channel capacity (C) or maximum data rate that an analog channel can transmit is limited by the frequency bandwidth (B) of the channel, and the noise (N) and signal (S) power in the channel, according to the equation C=B * log₂(1+S/N), where C is measured in bits per second (bps). For the PSTN, the estimated channel capacity at a typical distance of two subscribers from their respective central office (“CO”), say five kilofeet, is approximately 40 kbps (kilobits per second), assuming that B=3.0 KHz and S/N=40 dB. However, the Shannon-Hartley formula provides only a theoretical limit of channel capacity, and therefore it should be expected that the limit can only be approached using relatively sophisticated designs, and actually never achieved due to practical design limitations. Modems were introduced specifically to enable data transmission over the PSTN and have evolved over the years as sophisticated signal processing engines to support the highest possible data speed over standard telephone lines.

In addition to signal processing, modems typically perform other functions required by the PSTN to establish communication with the CO and ultimately with a remote subscriber. Such functions generally include going off-hook, detecting a dial tone from the CO, dialing a telephone number, and monitoring the response of the remote subscriber, all of which have become standard features of commercial modems. Therefore, commercial modems support automated connectivity to the PSTN according to specific standards dictated by the Federal Communication Commission (FCC) and the Electronics Industry Association (EIA) in the United States. For example, two standards applicable to PSTN terminal equipment are FCC Part 68 and EIA-470.

Generally, after initialization a modem receives commands directly from the user through a PC keyboard, for example, to dial the phone number of a remote subscriber. Any information entered by the user at this stage of the communication process is interpreted by the modem as a “command” to execute a specific function, such as “dial”, for example. This mode of operation is referred to as “command mode”. After communication with a remote modem is established at an appropriate data rate, the modem sends a “CONNECT” message to the user and immediately switches to “data mode.” In data mode, the modem stops “interpreting” any data received from the host PC (local user) as a command to execute, and provides exclusively the only functionality of transferring data reliably between the two remote locations. The user can switch from data mode back to command mode by entering a predetermined “escape” command, which is typically a unique sequence of binary data the modem can distinguish from a normal stream of data.

A block diagram of a typical data communication system employing a prior-art modem is shown in FIG. 1. The diagram shows a user interface 10, a host processor 11, a modem 12, a Public Switched Telephone Network (“PSTN”) 13, and the Internet 14. User interface 10 typically comprises a keyboard and display monitor, for example, with any necessary hardware/software to allow the user to send and receive data to and from a host processor 11. Host processor 11 contains or “hosts” modem 12, typically through a standard serial interface, for connection and data communication to the PSTN 13. The host processor 11 may comprise a PC, for example. The PSTN 13 connects the data communication system to a compatible system at a remote end within the PSTN 13, or alternatively to the Internet 14.

The Modem 12 includes three main components: a controller 15, a data pump 16 and a telephone line interface or data access arrangement (DAA) 17. Controller 15 performs connectivity functions to the PSTN 13 and implements any desired error correction and data compression algorithms. Typically, the controller 15 executes a program stored in a read-only memory (ROM) 8, and requires a temporary storage such as random-access memory (RAM) 9 for error correction and data compression. The data pump 16 includes a digital signal processor (DSP) 18 and a coder/decoder (CODEC) 19. The DSP 18 processes signals to and from the telephone line in the digital domain, and its complexity generally determines the data speed of the modem, with the limitation imposed by the channel according to the Shannon-Hartley theorem. The CODEC 20 is basically a combination of a conventional analog-to-digital converter (ADC) (not shown) and a conventional digital-to-analog converter (DAC) (not shown), and serves as an interface between the DSP 18 and the DAA 17. The DAA 17 is simply an analog interface to the telephone line. It performs functions such as DC loop control, impedance conditioning, two-to-four wire conversion (echo cancellation), ring detection, and the like. These functions are well known to those skilled in the art of modem design.

Referring now to the diagram of FIG. 2A, the hierarchy of protocol layers is shown. Beginning with an application layer 22, which includes the various protocols such as File Transfer Protocol (“FTP”) 23, Simple Mail Transfer Protocol (“SMTP”) 24, and Hyper Text Transfer Protocol (“HTTP”) 25. The Application Layer 22 is the top layer of the OSI seven-layer model. This layer handles issues like network transparency, resource allocation, and problem partitioning. The application layer 22 is concerned with the user's view of the network (e.g. formatting electronic mail messages).

FTP is a client-server protocol that allows a user on one computer to transfer files to and from another computer over a TCP/IP network. SMTP is used to transfer electronic mail between computers. It is a server-to-server protocol, so other protocols are used to access the messages. HTTP is a client-server TCP/IP protocol used on the World Wide Web for the exchange of HTML documents.

The next layer is a transport layer 26, which is the middle layer in the Open Systems Interconnection (OSI) seven-layer model. The transport layer determines how to use the network layer to provide a virtual error-free, point-to-point connection so that host A can send messages to host B and they will arrive un-corrupted and in the correct order. It establishes and dissolves connections between hosts and is used by the application layer 22. This layer includes a TCP 27, which is built on top of the Internet Protocol (IP). Layer 26 adds reliable communication, flow-control, multiplexing and connection-oriented communication, and provides full-duplex, process-to-process connections.

Next is the Internet layer 28, which includes an IP 29 for the Internet Protocol, which is a connection-less, best-effort package switching protocol that provides packet routing and re-assembly through the data link layer. Following this is a Network Access Layer 30, which includes an LLC 31 for the Logical Link Control, a PPP 32 for the Point-to-Point Protocol and a Modem 33. The LLC sub-layer 31 presents a uniform interface to the user of the data link service, usually the network layer. The PPC 32 is the protocol defined in the Internet standard for transmitting network layer data-grams (e.g. IP packets) over serial point-to-point links.

Referring now to the prior art sequence shown in FIG. 2B, the process begins with a START bubble 39 followed by an initialization step 40. The modem is initialized to a factory default setting stored in “firmware” (software algorithms stored in non-volatile memory) or a setting previously stored (generally in non-volatile memory) by the user. The user may also change this setting by issuing additional commands. These commands generally set the modem to accept or initiate error correction, data compression, and to accept or reject various modulations and line speeds. The modem generally responds to these commands with an “OK” message if the command has been accepted and executed (diamond 41), or an “ERROR” message if the command cannot be understood or executed, whereupon operation of the modem is terminated (block 42).

After the modem is successfully initialized, the user can instruct the modem to dial a remote telephone number (block 43). Generally, this is done by issuing an “ATD” command followed by the “telephone number” to be dialed. The modem automatically dials the remote number using multi-frequency dial tones (DTMF) or loop-current pulses, also known as pulse dialing.

The modem then monitors the telephone line for connection progress events, such as a busy tone or a response from a remote modem. When the remote modem answers the call (block 44), a “handshake” communication procedure (block 45) begins according to the configuration previously defined during initialization. Generally, modems are set to handshake at the highest common speed. Alternatively, a maximum speed can be set during initialization in order to improve the reliability of the connection or to reduce the handshake time.

Next, when a common line protocol has been found and the modems are synchronized to one-another, the modems may optionally establish an error-corrected link and add data compression (block 46). The modems do not perform any monitoring or analysis of the data flow, except in some specific cases such as required by network management, to detect an escape (command) sequence, or other proprietary scheme.

The principal function of modems before the advent of the Internet was a “client-to-client” link with a remote system to communicate data (as opposed to voice) within the PSTN. In the late 1980's, for example, a typical modem application was to start a terminal program on a PC. This was a program that interfaced with the PC keyboard and display monitor for communication to the PC serial port where the modem was connected. A set of predefined commands, also known as the “AT command set,” allowed control of the modem through the terminal program.

The AT command set is the industry standard adopted by most modem manufacturers and endorsed by the International Telecommunication Union (ITU) under its V.250 and V.251 standards. The AT command set is based on sending instructions to the modem using a string of characters for each command, preceded by the prefix “AT” (hence the name). Historically, prefix AT preceded a modem command to prompt the modem for (AT)tention to the command string that followed.

Typically, a modem is initialized in command mode and the user types command string “ATDT” followed by the phone number of a remote PSTN subscriber to instruct the modem to dial that phone number. The modem executes the command by going off-hook, detecting a dial tone, and dialing out the phone number. At the remote location, the answering modem is in standby waiting for a telephone call and, upon detection of a ring signal, goes off-hook to answer the call and establish communication with the calling modem. Once communication is established, the modem switches to data mode and data can be exchanged between the two modems either as text or as a binary file. To switch from data mode to command mode, the user can send an escape command such as the Hayes escape sequence, denoted by “[delay] +++ [delay],” i.e., absence of data (delay) for typically one second, followed by three characters “+”, followed again by an absence of data (delay) for one second. Upon recognition of an Hayes escape sequence, the modem switches back to command mode and interprets any characters preceded by “AT” as commands to execute.

The traditional modem provides a complete stand-alone module for a client-to-client connection through the PSTN 13. Two stations at each end of the modem communication link exchange information back and forth with only a keyboard, a monitor, and a serial interface to the modem. For example, a security monitoring device is programmed to call a central monitoring station through a standard modem and send or receive information relating to the security status of a home or business. The security monitoring device typically sends a command to the modem to dial a telephone number, and then transmits or receives data to and from the station after communication is established. The modem manages all steps required to establish a reliable data link between the device and the station.

With the advent of network access technology and the Internet, a prior-art modem at the origination site (client) dials in to the central office using analog signals, then the central office routes the call digitally to an Internet Service Provider (ISP), which is the interface or link to the Internet. However, once a physical data link to the ISP is established, the traditional modem does not support the protocols required to transmit or receive “useful” data to and from the Internet. For example, if a client manages to dial the telephone number of an ISP using a traditional modem, it is impossible to send or receive information to and from the Internet after a connection with the ISP is established. To accomplish this, a separate host processor or server is required to implement certain software algorithms known as Internet stacks. Generally, ISP's provide customized software programs that support communication to the Internet, such as Telnet, Internet Explorer®, Netscape®, and the like. Such programs are generally executed by a host processor communicating to the modem, such as a PC.

It is clear from the above discussion that prior-art modems perform only the limited functions of connection and transmission of digital data through a band-limited analog channel. However, such modems do not have the capability to alter the data transmitted and received or take part in any other functions outside the reliable physical data link. In particular, modems do not interpret data or implement any protocols required to communicate with a network or the Internet, and generally require a separate processor to carry out Internet connectivity functions.

To the extent that network access technology has vrtually replaced the traditional client-to-client communication link over the PSTN, prior-art modems are now obsolete. The prior-art modem supports only communication through the PSTN (listening for dial tone, dialing a phone number, monitoring if there is a ring back signal or a busy signal, establishing connection with a remote modem, detecting ring, detecting caller ID, etc.). In particular, the prior-art modem does not support basic communication with the Internet such as: (1) sending or receiving e-mail, with or without file attachments, (2) uploading and downloading files or data to and from an Internet site using FTP protocol, (3) downloading files or data from an Internet site using HTTP protocol.

### SUMMARY OF THE INVENTION

In accordance with the present invention, an improved modem is provided which is capable of direct communication with the Internet without the use of a host processor or personal computer. The Internet modem of the present invention contains and implements the basic functions of sending and receiving e-mail, and uploading and downloading files and data to and from the Internet.

Accordingly, it is an object of the present invention to provide an improved modem that does not require a second processor or a personal computer to communicate with the Internet.

Another object of the present invention is to provide an improved modem that incorporates all the necessary software protocol stacks to communicate with the Internet.

Yet another object of the present invention is to provide an improved modem that incorporates a simple set of user interface commands for communication with an ISP.

Still another object of the present invention is to provide an improved modem which implements basic functions such as send and receive e-mail, or upload (FTP) and download (HTTP) files to and from the Internet through the telephone line.

Still other objects, features, and advantages of the present invention will become readily apparent to those skilled in the art from the following detailed description, wherein is shown and described only the preferred embodiment of the invention, simply by way of illustration of the best mode contemplated of carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive, and what is intended to be protected by Letters Patent is set forth in the appended claims. The present invention will become apparent when taken in conjunction with the following description and attached drawings, wherein like characters indicate like parts, and which drawings form a part of this application.

### BRIEF DESCRIPTION OF THE DRAWINGS

The general purpose of this invention, as well as a preferred mode of use, its objects and advantages will best be understood by reference to the following detailed description of an illustrative embodiment with reference to the accompanying drawings in which like reference numerals designate like parts throughout the figures thereof, and wherein:

FIG. 1 shows the principal components of a typical modem according to the prior art.

FIG. 2A is a diagram of the hierarchy of layers in using the Internet.

FIG. 2B is a flow chart showing operation of a prior-art modem.

FIG. 3 shows the components of a typical modem according to the present invention.

FIG. 4 shows an operational flow chart of the preferred firmware programming of a modem according to the present invention.

FIG. 5 shows an operational flow chart of an alternate embodiment of the present invention.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein specifically to provide an Internet Modem.

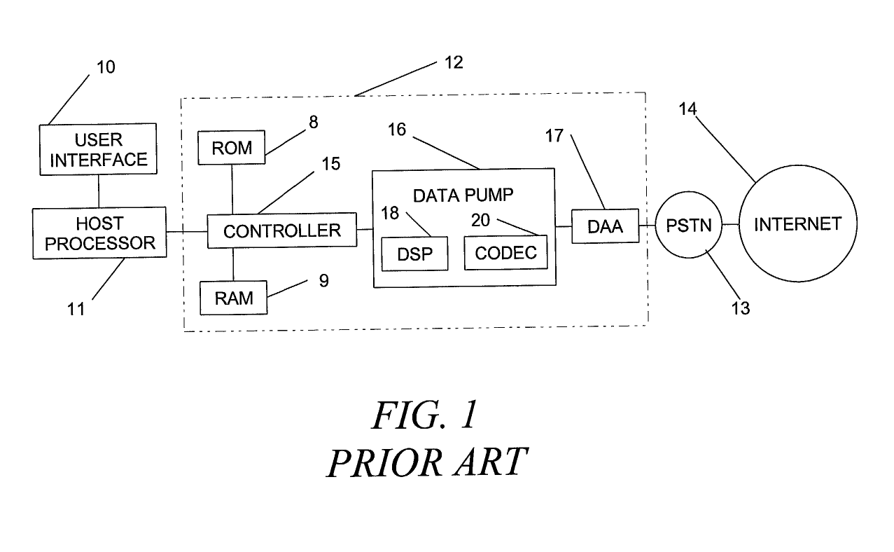

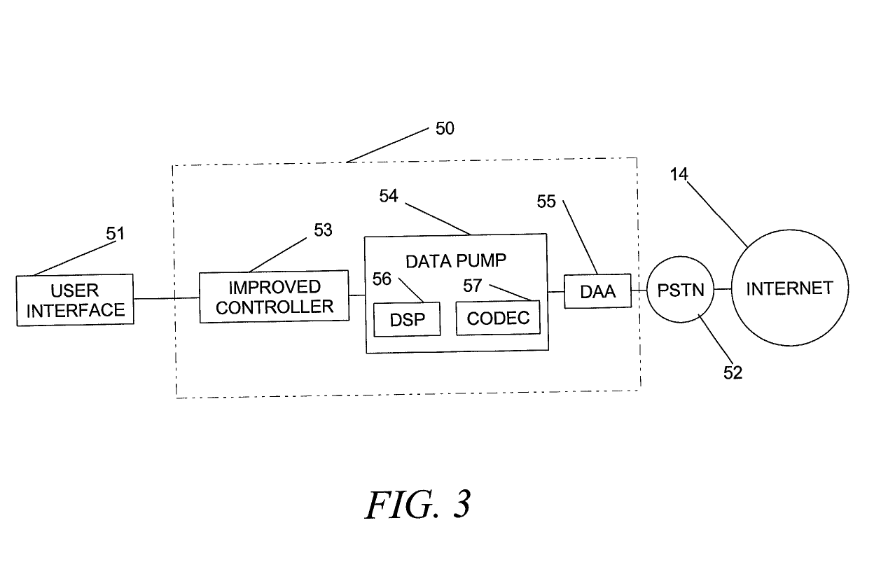

FIG. 3 shows an Internet modem 50 in accordance with the present invention and disposed between a user interface 51 and a PSTN 52. As in the prior art modem shown in FIG. 1, the Internet modem 50 contains a controller 53, a data pump 54, and a DAA 55. A part of the functionality previously contained in the host processor 11 (FIG. 1) is now contained in the preferred controller 53 in accordance with the present invention. Data pump 54 and DAA 55 operate in a manner similar to those described in connection with FIG. 1. Also, the data pump 54 includes a DSP 56 and CODEC 57 the same as the prior art device. Moving the required functionality from the host processor 11 (FIG. 1) to the controller 53 eliminates the need for a host processor or PC. This enables direct communication between user interface 51 and the Internet 14, via the PSTN 52. This direct communication eliminates the cost and complexity of a PC and its various software algorithms (not shown). Numerous novel and prior-art user interfaces 51 can now communicate directly with the Internet, thereby improving communications and reducing cost.

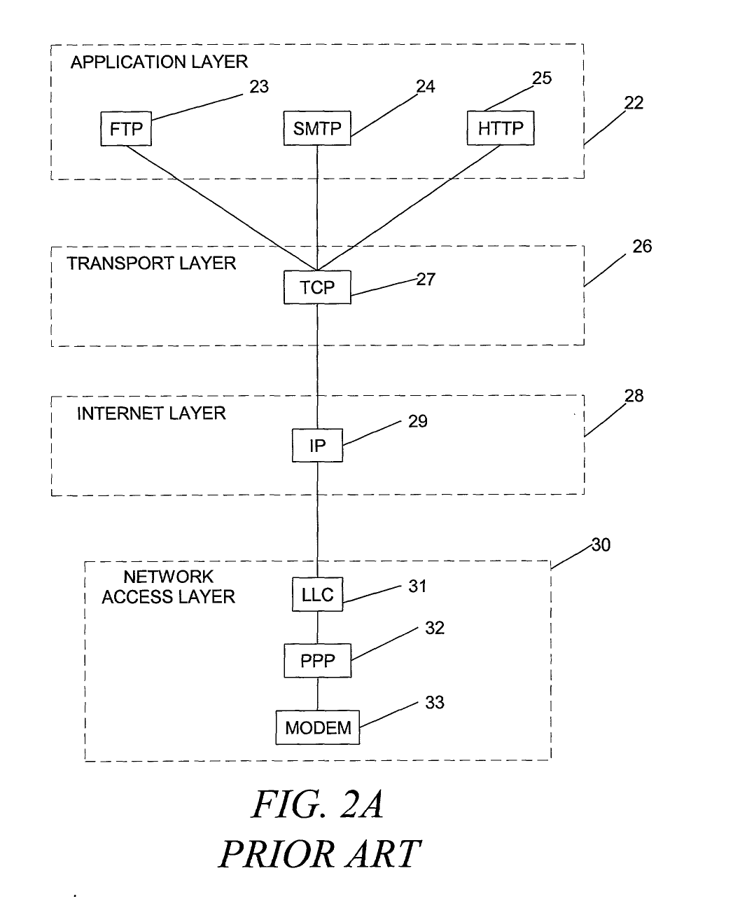

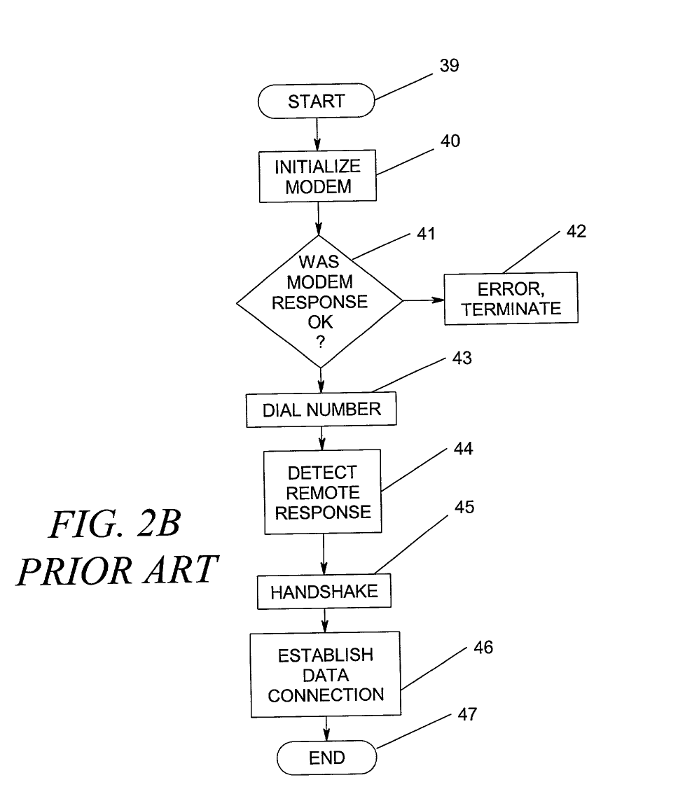

The improved modem 50 of the present invention allows the integration of functions typically implemented in a host controller, into the same controller used in a standard modem (e.g., modem 12—FIG. 2), which controls the data pump 54. The implementation of the improved modem 50 in accordance with the present invention results in substantial cost savings, and the hardware architecture becomes very economical. For example, a standard modem uses a total of 32K bytes of RAM, allocated as follows: 24K bytes for data compression algorithms and 8K bytes for error correction and general purpose. Typically, the 24K bytes used for data compression are associated with approximately 2,000 dictionary entries (symbols used in data compression algorithms). By decreasing the number of dictionary entries from 2K to 1K bytes (i.e., removing some symbols that are relatively rare, the compression factor is reduced by only a small percentage. Furthermore, when transmitting data to and from the Internet, most of the data content is already compressed, and therefore a loss of compression would not have any tangible consequence. As a result, by reducing the dictionary entries to 1K bytes, the RAM required to support data compression can be reduced to 12K bytes, thereby leaving approximately 12K bytes to implement TCP/IP stacks. As far as the ROM is concerned, the amount of software code required to implement Internet functions can be incorporated into the existing 128K bytes or 256K bytes of ROM that standard modems already use. Finally, the improved modem 40 can be effectively utilized to implement Internet functions, as opposed to using a host controller, thereby providing substantial cost savings and decreasing the physical size of the system.

### Definitions—Command Set for the Internet Modem

Prior-art modems have used the industry standard AT command set to establish a connection with the remote modem. In accordance with teachings of the present invention, the modem is not only used to establish the physical connection but also to establish a logical connection with the Internet through an ISP. This invention also allows the user of the Internet modem to use sophisticated applications such as sending an electronic message without requiring a host computer, PC, or similar equipment.

Because of the different usage model, the Internet modem requires a different command set. The following is an example of a new command set, which is based on the industry standard AT command.

### Configuration Command

The Configuration command is used to enable or disable Internet mode operation in the modem.

AT$NET - Set/Reset Internet mode

| | |
|---|---|
| Use | AT$NET = 1 |
| | or |
| | AT$NET = 0 |
| Purpose | Set (1) or Reset (0) the Internet mode |
| Note | If the modem does not implement the traditional |
| | mode of operation, it could be forced in AT$NET = 1 |
| | modem and this command could be bypassed |

### ISP Setup Commands

The ISP Setup commands are required to set up the information related to the ISP with whom the owner of the modem is registered.

| AT$P - Set phone number | |
|---|---|
| Use | AT$P = yyyzzzz |
| | or |
| | AT$P = 1xxxyyyzzz |
| Purpose | Set the phone number of the ISP (either 7 or 10 |
| | digits format) |
| Note | If the modem has a non-volatile storage, this |
| | value can be maintained between calls or after |
| | the modem is powered off. |
| AT$U - Set user name | |
| Use | AT$U = username |
| Purpose | Set the user name for the PAP or CHAP |
| | negotiation as part of the PPP negotiation |
| Note | If the modem has a non-volatile storage, this |
| | value can be maintained between calls or after |
| | the modem is powered off. |
| AT$W - Set password | |
| Use | AT$W = password |
| Purpose | Set the password for the PAP or CHAP negotiation |
| | as part of the PPP negotiation |
| Note | If the modem has a non-volatile storage, this |
| | value can be maintained between calls or after |
| | the modem is powered off. |

### E-Mail Setup Commands

The E-Mail Setup commands are required to setup the information related to the user who will be sending E-mails:

| AT$S - Set SMTP | |
|---|---|
| Use | AT$S = smtp.network.com |
| Purpose | Set the name of the SMPT server (used to send E- |
| | mails) |
| Note | If the modem has a non-volatile storage, this |
| | value can be maintained between calls or after |
| | the modem is powered off. |
| AT$3 - Set POP3 (Post Office Protocol) | |
| Use | AT$3 = mail.network.com |
| Purpose | Set the name of the POP3 server (used to receive |
| | E-mails). |
| Note | If the modem has a non-volatile storage, this |
| | value can be maintained between calls or after |
| | the modem is powered off. |
| AT$N - Set name | |
| Use | AT$N = username |
| Purpose | Set the user name (used in the From: while |
| | sending E-mails) |
| Note | If the modem has a non-volatile storage, this |
| | value can be maintained between calls or after |
| | the modem is powered off. |
| AT$E - Set E-mail Address | |
| Use | AT$E = E-mail address |
| Purpose | Set the user E-mail address (used in the Respond |
| | to field while sending E-mails) |
| Note | If the modem has a non-volatile storage, this |
| | value can be maintained between calls or after |
| | the modem is powered off. |

### ISP Dialing Command

The ISP Dialing Command is used to establish a connection with the ISP. The modem automatically dials the stored number, establish the PPP session, negotiate the parameters and report the result to the user.

AT$D - Dial the ISP

| | |
|---|---|
| Use | AT$D |
| Purpose | Establish a connection with the ISP |
| Note | Once the connection is established, the modem |
| | responds with CONNECT. If a connection with the |
| | ISP cannot be established, the modem responds |
| | with NO CARRIER |

### E-Mail Sending Commands

The E-Mail Sending Commands are required to send the information related to the ISP with whom the owner of the modem is registered

AT$M - Send a short E-mail message (no attachment)

| | |
|---|---|
| Use | AT$M |
| Purpose | Send a short E-Mail |
| Note | The E-mail is first stored in memory and then |
| | sent to the remote. |

The following shows a sequence of events while the DTE attempts to send an E-mail:

| DTE | DCE | Note |
|---|---|---|
| AT$M<cr> | | |
| | To: | |
| destination1, | | [max 256 characters] |
| destination2<cr> | | |
| | Subje | |
| | ct | |
| the_subject<cr> | | [max 64 characters] |
| | Text: | [max 1024 characters] |
| email text <cr><cr> | | terminate with <cr><cr> |
| | ID = xx | Indicate the reference of |
| | | this E-mail |
| | OK | |

### Definitions—Internet Protocols and Other Terms

A number of standardized protocols are used in communication with the Internet. They are listed here for reference. Information on such protocols is generally published as Request for Comments (RFCs), through the Internet Network Information Center (NIC), for example.

### Link Control Protocol (LCP)

In order to establish communication over a point-to-point link, each end of the PPP link must first send LCP packets of data to configure and test the data link. The Internet modem uses two classes of LCP packets:

a) Link Configuration packets used to establish and configure a link;

b) Link Termination packets used to terminate a link.

Each LCP packet is encapsulated in the PPP Information field. More details are described in RFC 1661.

### PPP Authentication Protocols (PPP)

PPP defines an extensible Link Control Protocol, which allows negotiation of an Authentication Protocol for authenticating its peer before allowing Network Layer protocols to transmit over the link. The Point-to-Point Protocol provides a standard method of encapsulating Network Layer protocol information over point-to-point links. More details are described in RFC 1334.

### PPP Internet Protocol Control Protocol (IPCP)

PPP IPCP is the Network Control Protocol (NCP) for establishing and configuring the IP over PPP. The IP Control Protocol (IPCP) is responsible for configuring, enabling, and disabling the IP protocol modules on both ends of the point-to-point link. More details are described in RFC 1332.

### Internet Protocol (IP)

The IP is specifically limited in scope to provide the functions necessary to deliver a package of bits (an Internet data-gram) from a source to a destination over an interconnected system of networks. There are no mechanisms to augment end-to-end data reliability, flow control, sequencing, or other services commonly found in host-to-host protocols. The Internet protocol can capitalize on the services of its supporting networks to provide various types and qualities of service. More details are described in RFC 791.

### User Data-gram Protocol (UDP)

The UDP is defined to make available a data-gram mode of packet-switched computer communication in the environment of an interconnected set of computer networks. This protocol assumes that the IP is used as the underlying protocol. The UDP module is able to determine the source and destination Internet addresses and the protocol field from the Internet header. More details are described in RFC 768.

### Transmission Control Protocol (TCP)

TCP is intended for use as a highly reliable host-to-host protocol between hosts in packet-switched computer communication networks, and in interconnected systems of such networks.

TCP interfaces on one side to user or application processes and on the other side to a lower level protocol such as IP. More details are described in RFC 793.

### MIME (Multipurpose Internet Mail Extensions)

MIME is a mechanism for specifying and describing the format of Internet message bodies. More details are described in RFC 1521.

### Simple Mail Transfer Protocol (SMTP)

SMTP allows transferring mail reliably and efficiently. SMTP is independent of the particular transmission subsystem and requires only a reliable ordered data stream channel. More details are described in RFC 821.

### TELNET

The purpose of the TELNET Protocol is to provide a fairly general, bi-directional eight-bit byte oriented communications facility. Its primary goal is to allow a standard method of interfacing terminal devices and terminal-oriented processes to each other. It is envisioned that the protocol may also be used for terminal-terminal communication (“linking”) and process-process communication (distributed computation). More details are described in RFC 854.

### File Transfer Protocol (FTP)

The objective of FTP is to transfer data reliably and efficiently. FTP requires Telnet Protocol. More details are descibed in RFC 959.

### Using the Internet Modem—Table I

With the addition of a very limited set of IP commands, an Internet modem can be used to easily send e-mail to a remote user. Table I shows the commands from the user interface to the modem, and the modem's responses.

TABLE I

| From User | | |
|---|---|---|
| Interface | From Modem | Comments |
| AT$NET = 1 | | The modem is set to be in the |
| | | Internet mode |
| | OK | The modem acknowledges |
| | | receiving the previous command |
| AT$P = <phone | | The user sets the modem with |
| number> | | the phone number of the ISP |
| | OK | The modem acknowledges |
| | | receiving the previous command |
| AT$U = <name> | | The user sets the modem with |
| | | the name that was giving to |
| | | him by the ISP |
| | OK | The modem acknowledges |
| | | receiving the previous command |
| AT$W = <passwo | | The user sets the modem with |
| rd> | | the password agreed upon with |
| | | the ISP |
| | OK | The modem acknowledges |
| | | receiving the previous command |
| AT$S = <SMTP | | The user sets the modem with |
| name> | | the name of the SMTP server. |
| | | The ISP discloses this |
| | | information to the user when |
| | | he registers his account. |
| | OK | The modem acknowledges |
| | | receiving the previous command |
| AT$N = <user | | The user sets the modem with |
| | | his name. This field appears |
| | | when sending an E-mail in the |
| | | From: field. |
| | OK | The modem acknowledges |
| | | receiving the previous command |
| AT$E = <email | | The user sets the E-mail |
| address> | | address that will be used as a |
| address> | | return address. |
| | OK | The modem acknowledges |
| | | receiving the previous command |

The modem is now configured as an Internet Modem. Some
modems may allow the user to save this information in a
non-volatile storage.

| | | |
|---|---|---|
| AT$D | | The user now wants to send E- |
| | | mail. It uses the AT$D |
| | | command. The modem will |
| | | automatically dial the ISP |
| | | server number, establish the |
| | | physical connection with the |
| | | remote modem and establish the |
| | | PPP connection with the remote |
| | | host. |
| | CONNECT | Traditional modems would use |
| | | the CONNECT indication to |
| | | inform the user that a |
| | | physical connection has been |
| | | established with the remote |
| | | modem. The Internet Modem also |
| | | indicates that the Internet |
| | | Modem is connected to the |
| | | Internet network. |
| AT$M | | The user indicates that he |
| | | wants to send an E-mail |
| | To: | The modem acknowledges the |
| | | command and prompts the user |
| | | for the E-mail address (or a |
| | | list of addresses) of the |
| | | remote user. |
| Address1, | | The user sends the E-mail |
| Address2 | | addresses (in this example, |
| | | two addresses) |
| | Subject: | The modem acknowledges the |
| | | command and prompts the user |
| | | for the E-mail subject |
| My_Subject | | The user sends the subject of |
| | | the message. |
| | Text: | The modem acknowledges the |
| | | command and prompts the user |
| | | for the text of the E-mail |
| Data.... | | The user sends the text of the |
| | | E-mail. The text is ended when |
| | | the modem receives a commonly |
| | | agreed ending sequence. |
| | ID = 1234 | The modem acknowledges |
| | | receiving the text. It may |
| | | send an ID to the user. This |
| | | ID may be used to track the |
| | | activity of the Internet |
| | | Modem. |
| | OK | The modem confirms that the E- |
| | | mail message was correctly |
| | | sent. |
| ATH | | The user may send another |
| | | message or decide to hang-up |
| | | the communication with the |
| | | server. The Internet Modem |
| | | proceeds with an orderly |
| | | disconnect by first closing |
| | | the Internet Protocol and then |
| | | closing the physical |
| | | connection |
| | OK | The modem confirms that the |
| | | telephone line is released. |

As a method, the improved modem 40 in accordance with the present invention allows the integration of functions typically implemented separately in a modem operating with a host controller (e.g., modem 12—FIG. 1), into a set of standard functions supported by the improved modem 40 for direct communications with the Internet. Just like the traditional modem 12 uses the AT command set to support connection and communication with the PSTN 13, the improved modem 40 uses an extended set of AT commands to support connection and basic communication with the Internet. For example, a typical method to access the Internet involves two separate steps, typically implemented in two separate systems:

1) connection to the PSTN 13 by the modem 12; and,

2) connection to the Internet, fully supported by a host processor 11.

The method of the present invention integrates both of these steps into one single, efficient method supported by one single, integrated system. In Windows, for example, a typical way to send e-mail over the Internet is to establish a connection to a server using Dial-Up Networking (i.e., a Windows utility), which represents the host controller software program that interfaces with the modem 12; and, then use another program to run the SMTP protocol. The host processor 11 supports the PPP, TCP/IP and SMTP protocols (Dial-Up Networking, followed by an e-mail “SMTP” program), whereas the modem 12 supports strictly a connection to the PSTN 13. If an Internet modem, such as modem 40, were to be used to perform the same function (i.e., send an e-mail over the Internet), the user would not need to invoke two or more separate software programs running on the host processor 11, but rather the user could open the modem serial port with Hyper-Terminal (a simple program used to communicate to the serial port where the modem is connected) and send an e-mail using an appropriate sequence of AT commands.

The benefits of this added functionality to the improved modem 40 can be extended to embedded systems, where the advantages are considerably more pronounced because the host processor 11 is not available to start with (as opposed to the case of a PC, where the host processor is virtually free). For example, telephones, vending machines, or set-top boxes intended for communication over the Internet can be implemented with a simple low-cost controller 43, typically having integrated RAM and ROM communicating directly with the modem 40, which provides a standard interface for communication over the Internet.

Today, on the other hand, to support communication over the Internet it becomes necessary to utilize a more expensive processor to implement Internet stacks in addition to the modem, virtually and unnecessarily duplicating functionality, which can be effectively delegated to the improved modem controller 53.

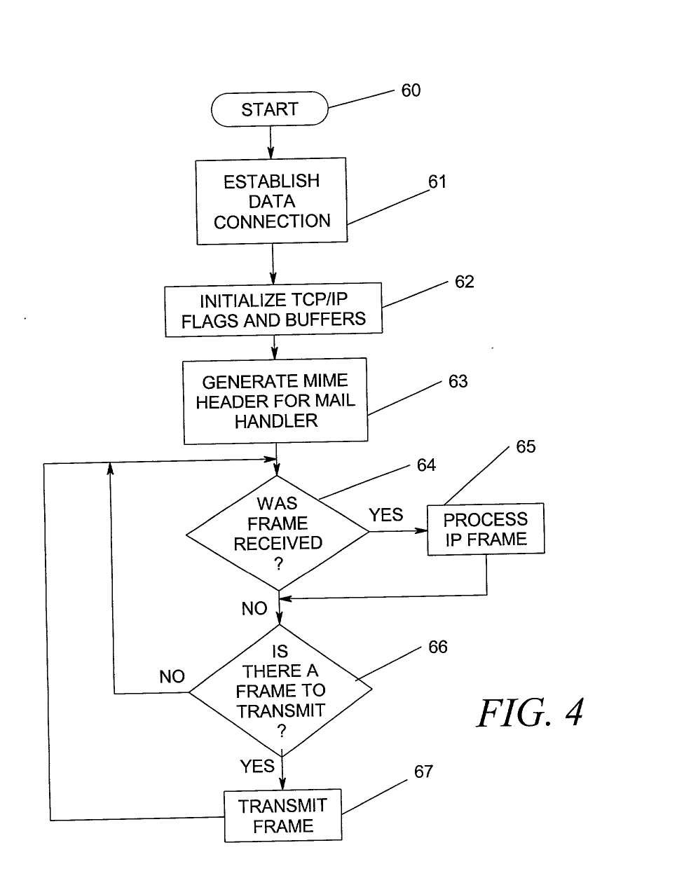

Referring now to FIG. 4, an operation of sending e-mail is illustrated in flow chart form. The process begins with a start bubble 60, followed by a step of establishing a data connection (block 61) to an Internet server (described above) using a procedure similar to that used by the prior-art modem (also described above).

Once a physical connection is established with the server, the modem will initialize TCP/IP flags and buffers (block 62) in order to establish connection with the Internet. Next, using previously stored algorithmic steps (not shown), the modem generates a MIME header (data in a predetermined format) for the Internet mail handler (block 63). After this, the modem checks to see if it has received a frame of data from the ISP's server (diamond 64). If it has, it processes the information in that frame (block 65).

Following the above, the modem checks to see if its output data buffer contains a frame of data to be transmitted to the ISP's server (diamond 66). If there is no frame to be sent, then the modem checks again to see if a frame of data has been received (feedback loop to diamond 64), and so forth. If there is a frame to be sent (i.e., yes exit from the diamond 66), then the frame is transmitted (block 67) to the ISP's server and the modem checks again to see if a frame has been received, (i.e., return to the diamond 64), and so forth.

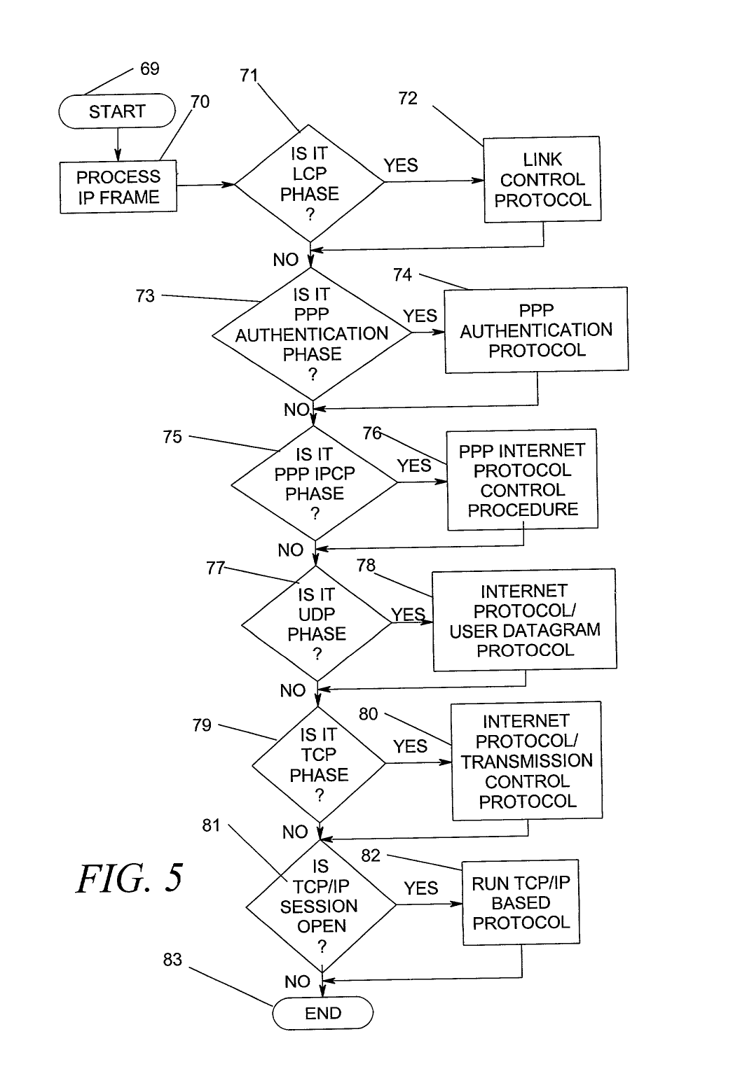

Referring now to FIG. 5, the operation of a minimal system is shown in flow-chart form. Because of costs and other considerations, certain products may have limited memory, preventing inclusion of a complete Real Time Operating System (RTOS). One solution is to have a simple round-robin algorithm that processes the IP frames as they are received by the modem. A simple sequencing will ensure that the different protocols are analyzed in the correct order. In order to save memory space, a minimal set of options can be implemented, as follows.

The minimal modem system's firmware first receives and processes an IP frame (block 70). Next, the firmware analyzes the frame to determine if the phase of connection protocol contained in the frame is Link Control Protocol (“LCP”) (diamond 71). If the answer to this inquiry YES, then the LCP responses are generated by the modem's firmware and sent to the ISP's server (block 72). On the other hand, if the answer to this inquiry is no, then, the firmware inquires whether or not it is PPP Authentication Protocol (diamond 73). If present, then the PPP Authentication Protocol responses are generated and sent by the modem's firmware (block 74). Numerous other PPP options are available, however a minimal system requires only Authentication.

Following the above, if the answer to the inquiry in the diamond 73 is no, then the firmware checks for PPP Internet Protocol Control Procedure (“IPCP”) (diamond 75). If the answer to this inquiry is yes, then the appropriate responses are generated and sent by the modem's firmware (block 76). On the other hand, if the answer to the inquiry in the diamond 75 is no, then the firmware checks for User Data-gram Protocol (“UDP”) Phase (diamond 77). If the answer to this inquiry is yes, i.e., UDP is present, then the appropriate IP/UDP responses are generated and sent by the modem's firmware (block 78).

If the answer to the inquiry in the diamond 77 is no, then the firmware checks for Transmission Control Protocol (“TCP”) (diamond 79). If TCP/IP is present, then the appropriate TCP/IP responses are generated and sent by the modem's firmware (block 80).

If the answer to the inquiry depicted by the diamond 79 is no, then the firmware checks to see if the TCP/IP session is open (diamond 81). If so, then the firmware runs TCP/IP protocol (block 82). After the TCP/IP session has finished, communication is ended (block 83).

It is thus seen that the present system provides an Internet modem that is independent of a host computer. A modem is provided that lets users enter information such as the ISP's telephone number, the user name, the user's password, and any other TCP/IP address required. This information can be stored in a user profile, as telephone numbers are stored in prior-art modems. Simple commands can be used to perform the basic functions above.

The Internet modem offers many advantages. Most of the information and data traffic in the future will be routed through the Internet information “superhighway”. It is inconceivable that a PC or add-on processor should be required with a modem each time information is to be exchanged through the Internet. Using the present system, two users can communicate through the Internet in the same way as two users can communicate between two prior-art modems today.

Although Internet-capable, the present modem is also useful to the user who dials in to a private network, since client-to-client connection is still within the capabilities of the Internet modem. Thus the present modem serves a dual purpose.

Historically, modem manufacturers have operated independently from network access manufacturers, primarily due to the separate commercial evolution of these technologies. As a result, the integration of the two has not yet become reality, partially because PCs are readily available and the Internet has not yet been deployed to its fullest potential. However, as more and more “embedded” systems such as game consoles, security devices, ATM terminals, and the like communicate directly with the Internet, the need for a separate processor to handle Internet protocol will become not only expensive, but also relatively complex to manage for the average Internet appliance manufacturer. Therefore, as the public information “network” over the years has shifted from the PSTN to the Internet, the traditional modem must change accordingly to an Internet modem in order to continue to support a simple user interface to the more sophisticated communication mechanism.

The invention can also be implemented in any stand-alone modem that communicates to the Internet or dials up to a network, including DSL, cable, and wireless modems. Therefore, one could conceive of a stand-alone DSL modem, for example, which with an appropriate user interface (keyboard and monitor), which would be capable of performing simple Internet functions such as send and receive email, FTP data to an Internet server, and download files from an Internet site, without the need for a processor or personal computer.

While the invention has been particularly shown and described with reference to a preferred embodiment, it will be understood by those skilled in the art that various changes in form and detail may be made therein without departing from the spirit and scope of the invention.

Those skilled in the art will appreciate that various adaptations and modifications of the just-described preferred embodiments can be configured without departing from the scope and spirit of the invention. Therefore, it is to be understood that within the scope of the appended claims, the invention may be practiced other than as specifically described herein.

What is claimed is:

1. An apparatus for communicating over the Internet with a user interface but without the use of a host computer, said apparatus comprising:
a. a controller communicating with said user interface and programmed to share resources with both said modem functions and said user interface functions;
b. a data pump having:
i) a CODEC for converting analog signals to digital signals and for converting digital signals to analog signals;
ii) a DSP for processing digitized samples from said CODEC;
c. a DAA disposed for interfacing communications with an analog telephone line, which connects to the Internet.

2. The apparatus as in claim 1 further including a programmable ROM coupled to said controller for storing programs for use by said controller including programs for supporting Internet connectivity.

3. The apparatus as in claim 1 wherein said controller is programmed to implement connection of said apparatus to a telephone line and to further implement connection to the Internet.

4. An improved apparatus for communicating over the Internet with a user interface but without the use of a host computer, said apparatus including a data pump having a CODEC for performing A-to-D conversions; a DSP for processing digitized samples from said CODEC; a DAA disposed for interfacing communications with an analog telephone line, which connects to the Internet, wherein the improvement comprises:
a controller communicating with said user interface and programmed to implement connection of said apparatus to a telephone line and to further implement connection to the Internet.

5. The apparatus as in claim 4 further including a programmable ROM coupled to said controller for storing programs for use by said controller including programs for supporting Internet connectivity.

6. A method for connecting to the Internet without the use of a computer, comprising the steps of:
a. establishing a data connection;
b. initializing TCP/IP flags and buffers;
c. generating MIME header for mail handling;
d. determining whether or not an IP frame has been received, and if yes;
e. processing said IP frame;
f. determining whether or not there is a frame to be transmitted; and if yes;
g. transmitting said frame and returning to step d to repeat the process.

7. The method as in claim 6 further including the step of determining if said IP frame is LCP phase, and if so, linking to control protocol.

8. The method as in claim 6 further including the step of determining if said IP frame is PPP authentication phase, and if so, linking to said PPP authentication protocol.

9. The method as in claim 6 further including the step of determining if said IP frame is PPP IPCP phase, and if so, linking to said PPP Internet protocol control procedure.

10. The method as in claim 6 further including the step of determining if said IP frame is UDP phase, and if so, linking to an Internet protocol/user data-gram protocol.

11. The method as in claim 6 further including the step of determining if said IP frame is TCP phase, and if so, linking to an Internet protocol/transmission control protocol.

12. The method as in claim 6 further including the step of determining if TCP/IP session is open, and if so, running TCP/IP based protocol.

13. A program storage medium readable by a computing device in a modem including a storage device, said storage medium tangibly embodying a program of instructions executable by said computing device to perform method steps for connecting to the Internet without the use of a computer, said method comprising the steps of:
for connecting to the Internet without the use of a computer, comprising the steps of:
h. establishing a data connection;
i. initializing TCP/IP flags and buffers;
j. generating MIME header for mail handling;
k. determining whether or not an IP frame has been received, and if yes;
l. processing said IP frame;
m. determining whether or not there is a frame to be transmitted; and if yes;
n. transmitting said frame and returning to step d to repeat the process.

14. The storage medium as in claim 13 further including the step of determining if said IP frame is LCP phase, and if so, linking to control protocol.

15. The storage medium as in claim 6 further including the step of determining if said IP frame is PPP authentication phase, and if so, linking to said PPP authentication protocol.

16. The storage medium as in claim 13 further including the step of determining if said IP frame is PPP IPCP phase, and if so, linking to said PPP Internet protocol control procedure.

17. The storage medium as in claim 13 further including the step of determining if said IP frame is UDP phase, and if so, linking to an Internet protocol/user data-gram protocol.

18. The storage medium as in claim 13 further including the step of determining if said IP frame is TCP phase, and if so, linking to an Internet protocol/transmission control protocol.

19. The storage medium as in claim 13 further including the step of determining if TCP/IP session is open, and if so, running TCP/IP based protocol.
